(19) United States
(12) Patent Application Publication
(10) Pub. No.: US 2022/0226191 A1
(43) Pub. Date: Jul. 21, 2022

(54) LOW TEMPERATURE VIALS AND VIAL ASSEMBLIES

(71) Applicant: Janssen Biotech, Inc., Horsham, PA (US)

(72) Inventors: Christopher M. Folta, Conshocken, PA (US); Roger P. Asselta, South Harrison Township, NJ (US)

(21) Appl. No.: 17/608,507

(22) PCT Filed: May 1, 2020
(86) PCT No.: PCT/IB2020/054157

§ 371 Date: Nov. 3, 2021

Related U.S. Application Data
(60) Provisional application No. 62/843,073, filed on May 3, 2019.

(51) Int. Cl. A61J 1/14; A61J 1/06; B65D 51/00

(52) U.S. Cl. CPC A61J 1/1406; A61J 1/065; B65D 51/002; A61J 1/1468; A61J 1/1412

(57) ABSTRACT

Vials and vial assemblies for storing a medicament in low temperature environments are provided. In one exemplary embodiment, a vial is provided that includes a base portion and a finish portion. The finish portion has an outer surface and an inner surface, in which the inner surface defines a channel that is configured to receive a first portion of a deformable sealing member. The finish portion on the outer surface thereof includes a surface feature that is configured to engage with a second portion of the deformable sealing member. The surface feature is configured to remain engaged with the second portion of the deformable sealing member when the deformable sealing member contracts from a first configuration to a second configuration, thereby maintaining a seal between the finish portion and the deformable sealing member.

### FIELD

Vials and vial assemblies are provided for storing a medicament in low temperature environments.

### BACKGROUND

Medicaments are typically packaged in vials, such as glass or plastic vials, with a stopper (e.g., rubber stoppers) sealed thereto. However, when exposed to low temperature conditions (e.g., dry ice or cryogenic temperatures), the seal between the vial and the stopper can be compromised. This can be due to the difference between the coefficients of thermal expansion of the vial and the stopper. In low temperature environments, the stopper can shrink significantly more than the vial. For example, in low temperature environments, a glass vial can contract from about 0% to 3%, whereas a rubber stopper can contract up to about 8%. Further, commonly used butyl rubber stoppers can lose their elastic properties below their glass transition temperature (T_{g}), which poses a further risk to sealability. As a result, gaps can be created between the vial and the stopper, thereby allowing microbes to come into contact with and contaminate the medicament(s) contained in the vial. Further, under low temperature conditions, temporary loss of sealing integrity can allow cold, dense gas from the surrounding environment to leak into the vial. This ingress of gas can decrease the efficacy of the stored medicament(s) due to interaction with the gas and resulting vial overpressurization.

Accordingly, there is a need for improved vials and vial assemblies associated with storing a medicament in low temperature environments.

### SUMMARY

Various vials are disclosed for storing a medicament in low temperature environments.

In one embodiment, a vial is provided that includes a base portion and a finish portion. The base portion has an inner surface that defines a cavity that is configured to selectively hold a medicament. The finish portion has an outer surface and an inner surface. The inner surface defines a channel that is in fluid communication with the cavity, and the channel is configured to receive a first portion of a deformable sealing member. The finish portion on the outer surface thereof includes a surface feature that is configured to engage with a second portion of the deformable sealing member. The surface feature is configured to remain engaged with the second portion of the deformable sealing member when the deformable sealing member contracts from a first configuration to a second configuration, thereby maintaining a seal between the finish portion and the deformable sealing member.

The surface feature can have a variety of configurations. In some embodiments, the surface feature can be at least one of an indentation or a protrusion. At least one of the indentation and the protrusion can extend circumferentially about at least a portion of the finish portion. The indentation can be configured to receive the second portion of the deformable sealing member. The protrusion can be configured to penetrate the second portion of the deformable sealing member. The protrusion can terminate at a surface configured to push into the second portion of the deformable sealing member.

In some embodiments, the surface feature can include one or more concave indentations. In other embodiments, the surface feature can include one or more triangular protrusions. In yet other embodiments, the surface feature can include one or more triangular protrusions and one or more concave indentations.

In some embodiments, the surface feature can include one or more protrusions each having at least one planar surface. In such embodiments, the surface feature can include one or more concave indentations.

In some embodiments, the surface feature can include one or more protrusions having a frusto-polygonal shape. In other embodiments, the surface feature can include one or more indentations having an inverted frusto-polygonal shape.

In some embodiments, the surface feature can include first and second opposing walls that extend at an angle relative to each other. In certain embodiments, the angle can be from about 45 degrees to 55 degrees. In other embodiments, the angle can be from about 100 degrees to 110 degrees.

In some embodiments, the surface feature can have a width from about 0.2 mm to 0.5 mm. In some embodiments, the surface feature can have a height from about 0.1 mm to 0.5 mm.

The deformable sealing member can have a variety of configurations. In some embodiments, the deformable sealing member can have a substantially T-shaped configuration. In some embodiments, the deformable sealing member can have a Shore hardness from about 40 A to 70 A. In other embodiments, the deformable sealing member can have a Shore hardness from about 45 A to 55 A.

In some embodiments, the deformable sealing member can contract from the first configuration to the second configuration when the vial is exposed to a temperature from about −25° C. to −196° C. In certain embodiments, the temperature can be from about −85° C. to −75° C. In other embodiments, the temperature can be from about −196° C. to −120° C.

In some embodiments, the vial can include a neck portion that can extend from the base portion to the finish portion. The neck portion can have an outer surface and inner surface, in which the inner surface defines a channel that is in fluid communication with the channel of the finish portion and the cavity of the base portion.

In some embodiments, the vial can include a protective cap that can be configured to be selectively crimped around at least a portion of the finish portion so as to selectively seal the deformable sealing member to the finish portion. The protective cap can have a variety of configurations. In some embodiments, the protective cap can include a metallic foil.

In some embodiments, the vial can include the medicament disposed within the cavity of the base portion.

### BRIEF DESCRIPTION OF THE DRAWINGS

This invention will be more fully understood from the following detailed description taken in conjunction with the accompanying drawings, in which:

FIG. 1A is cross-sectional side view of one embodiment of a vial having a finish portion that includes an indentation;

FIG. 1B is cross-sectional magnified view of the finish portion in FIG. 1A;

FIG. 2 is a cross-sectional side view of the vial in FIG. 1A, showing a deformable sealing member inserted therein;

FIG. 3A is a cross-sectional view of the vial and the deformable sealing member in FIG. 2, showing a protective cap crimped about a portion of the finish portion of the vial and a portion of the deformable sealing member;

FIG. 3B is a cross-sectional magnified view of the finish portion, the deformable sealing member, and the protective cap of FIG. 3A;

FIG. 4A is a cross-sectional side view of another embodiment of a vial having a finish portion that includes a protrusion;

FIG. 4B is a cross-sectional magnified view of the finish portion in FIG. 4A;

FIG. 5 is a cross-sectional side view of the vial in FIG. 4A, showing a deformable sealing member inserted therein;

FIG. 6A is a cross-sectional view of the vial and the deformable sealing member in FIG. 5, showing a protective cap crimped about a portion of the finish portion of the vial and a portion of the deformable sealing member;

FIG. 6B is a cross-sectional magnified view of the finish portion, the deformable sealing member, and the protective cap of FIG. 6A;

FIG. 7A is a cross-sectional side view of another embodiment of a vial having a finish portion that includes an indentation and a protrusion;

FIG. 7B is a cross-sectional magnified view of the finish portion in FIG. 7A;

FIG. 8 is a cross-sectional side view of the vial in FIG. 7A, showing a deformable sealing member inserted therein;

FIG. 9A is a cross-sectional view of the vial and the deformable sealing member in FIG. 8, showing a protective cap crimped about a portion of the finish portion of the vial and a portion of the deformable sealing member;

FIG. 9B is a cross-sectional magnified view of the finish portion, the deformable sealing member, and the protective cap of FIG. 9A;

FIG. 10A is a cross-sectional side view of another embodiment of a vial having a finish portion that includes a protrusion;

FIG. 10B is a cross-sectional magnified view of a portion of the vial in FIG. 10A taken at 10B;

FIG. 10C is a cross-sectional magnified view of a portion of the vial in FIG. 10B taken at 10C;

FIG. 11A is a cross-sectional side view of another embodiment of a vial having a finish portion that includes an indentation; and

FIG. 11B is a cross-sectional magnified view of a portion of the vial in FIG. 11A taken at 11B.

### DETAILED DESCRIPTION

Certain exemplary embodiments will now be described to provide an overall understanding of the principles of the structure, function, manufacture, and use of the vials and vial assemblies disclosed herein. One or more examples of these embodiments are illustrated in the accompanying drawings. Those skilled in the art will understand that the vials and vial assemblies specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Various vials and vial assemblies are provided for storing a medicament at a low temperature. A “medicament” as used herein refers to a therapeutic agent (a drug, a biologic, a biological material, etc.) that when administered to a subject will have the intended prophylactic effect, e.g., preventing or delaying the onset (or reoccurrence) of an injury, disease, pathology or condition, or reducing the likelihood of the onset (or reoccurrence) of an injury, disease, pathology, or condition, or their symptoms or the intended therapeutic effect, e.g., treatment or amelioration of an injury, disease, pathology or condition, or their symptoms including any objective or subjective parameter of treatment such as abatement; remission; diminishing of symptoms or making the injury, pathology or condition more tolerable to the patient; slowing in the rate of degeneration or decline; making the final point of degeneration less debilitating; or improving a patient's physical or mental well-being. Non-limiting examples of suitable medicaments include chimeric antigen receptors t-cell (CAR-T), gene-modified, cell therapies, t-cells, stem cells, and tissue. As used herein, “low temperature” can include any temperature that is from about −196° to −25° C. For example, in some embodiments, a low temperature can be a temperature from about −85° C. to −75° C. or from about −196° C. to −120° C. In other embodiments, a low temperature can be a temperature between any of these recited temperature values.

In general, the vials include a finish portion that is designed to form and maintain a seal between the vial and a deformable sealing member under low temperature conditions. The finish portion includes a surface feature on its outer surface that is configured to engage with a portion of the deformable sealing member and to remain engaged when the deformable sealing member contracts from a first configuration to a second configuration. As a result, this engagement can maintain the seal between the vial and the deformable sealing member when the deformable sealing member, and thus the vial, are exposed to a low temperature. Thus, under low temperature conditions, leakage and contamination of the medicament(s) within the vials can be avoided. Further, ingress of the low temperature air and microbes surrounding the vial can be inhibited, thereby decreasing the risk of vial overpressurization and microbial contamination.

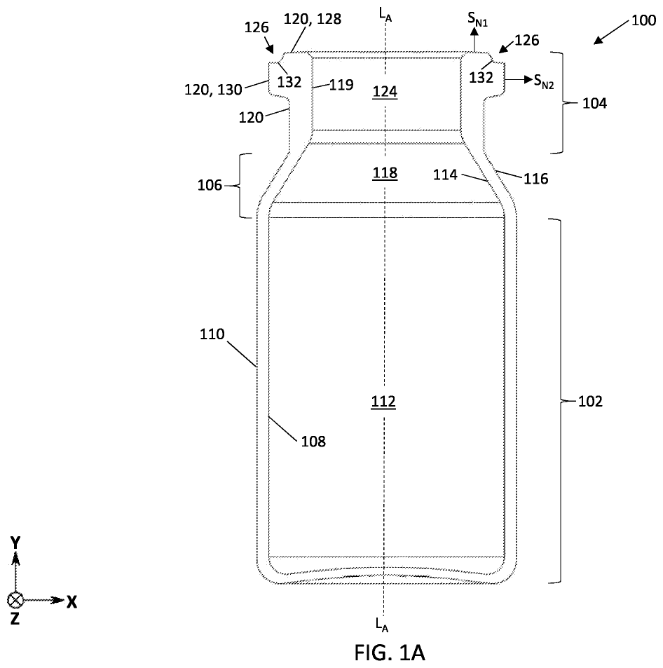

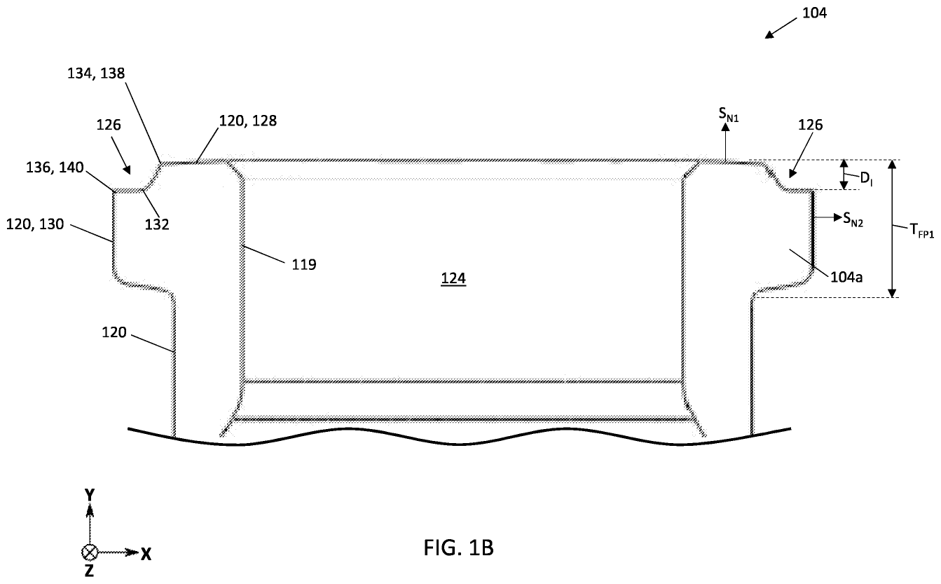

An exemplary vial can be formed of one or more materials, e.g., glass, polymer(s), etc. In some embodiments, a vial can be formed of glass. In other embodiments, a vial can be formed of one or more polymers. In yet other embodiments, different portions of a vial (e.g., base portion 102, 402, 702 finish portion 104, 404, 704, and/or neck portion 106, 406, 706 shown in FIGS. 1A-9B) can be formed of different materials.

The deformable sealing member can be what is commonly referred to as a stopper. An exemplary deformable sealing member can be formed of any suitable elastomeric material(s), e.g., thermoset rubbers, such as bromobutyl, chlorobutyl, and thermoplastic elastomers, such as halobutyl. In some embodiments, the deformable sealing member can have a Shore hardness from about 40 A to 70 A or from about 45 A to 55 A. In other embodiments, the deformable sealing member can have a Shore hardness between any of these recited Shore hardness values. The deformable sealing member can have a variety of configurations. For example, in some embodiments, the deformable sealing member can have a substantially T-shaped configuration. In other embodiments, the deformable sealing member can have a punched disk configuration. In yet other embodiments, the deformable sealing member can have any other possible suitable shape that is configured to be at least partially inserted into the vial (e.g., partially through a finish portion of the vial, or alternatively through the finish portion and at least partially through a neck portion of the vial).

An exemplary vial can include a variety of features to facilitate sealing and storing a medicament(s) therein, as described herein and illustrated in the drawings. However, a person skilled in the art will appreciate that the vials can include only some of these features and/or can include a variety of other features known in the art. The vials described herein are merely intended to represent certain exemplary embodiments.

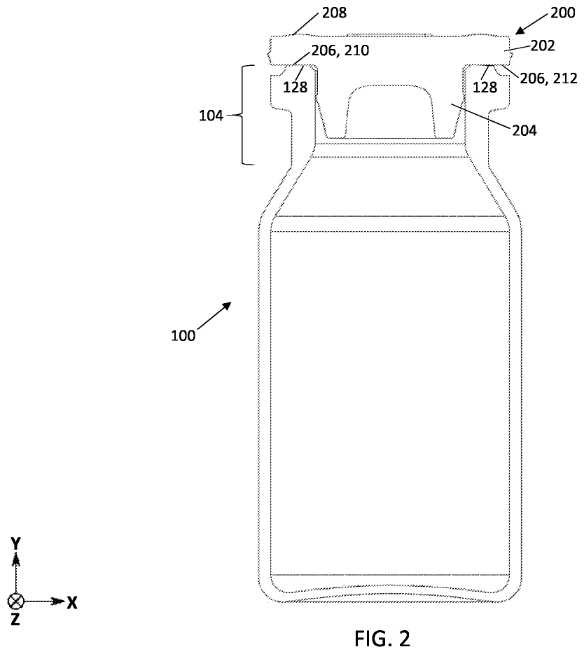

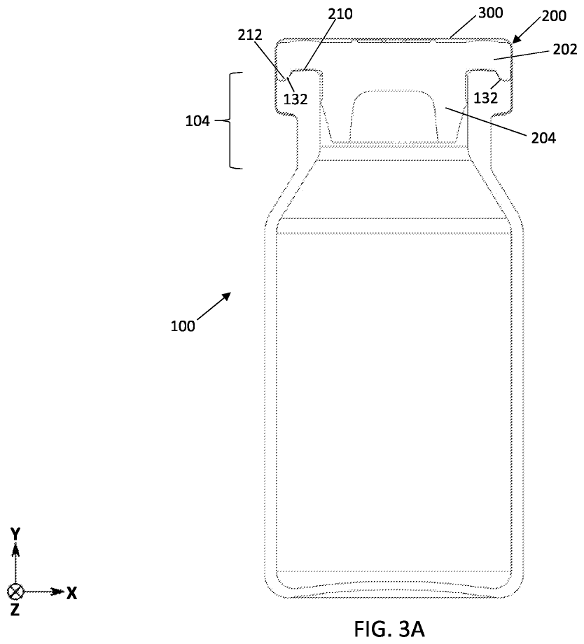

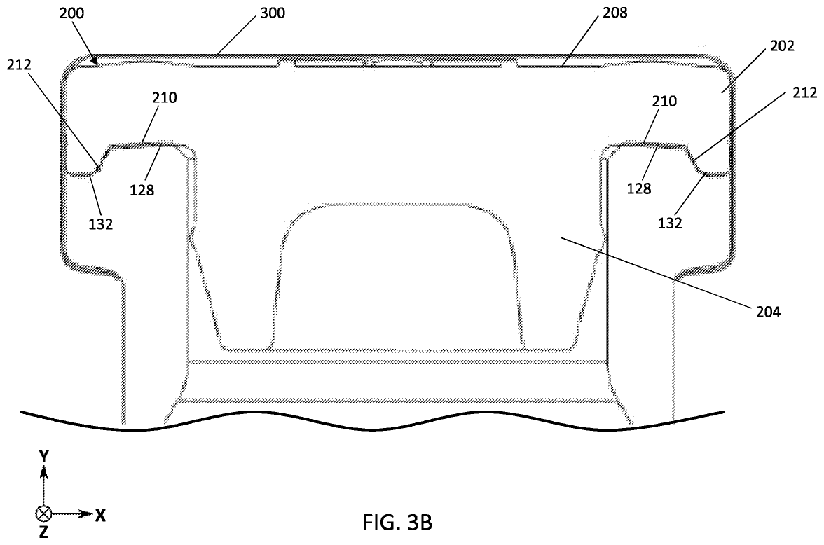

FIGS. 1A and 1B illustrate one exemplary embodiment of a vial 100 that is configured to store a medicament therein and maintain a seal with a deformable sealing member, like deformable sealing member 200 shown in FIGS. 2-3B, under low-temperature conditions. The illustrated vial 100 generally includes a base portion 102 and a finish portion 104. As shown, the vial 100 also includes a neck portion 106 that extends from the base portion 102 to the finish portion 104.

The base portion 102 includes an inner surface 108 and an outer surface 110. The inner surface 108 defines a cavity 112 within the base portion 102 that is configured to selectively hold the medicament. While the base portion 102 can have a variety of configurations, in this illustrated embodiment, the base portion 102 has a substantially cylindrical shape. In other embodiments, the base portion can have any other suitable shapes, e.g., a rectangular shape, etc.

While the neck portion 106 can have a variety of configurations, the neck portion 106 has an inner surface 114 and an outer surface 116. As shown, the inner surface 114 circumscribes and defines a channel 118 that extends through the neck portion 106. The channel 118 is in fluid communication with the cavity 112 of the base portion 102. In this illustrated embodiment, the inner surface 114 of the neck portion 106 has a tapered configuration. In other embodiments, the inner surface of the neck portion can have a non-tapered configuration.

While the finish portion 104 can have a variety of configurations, as shown, the finish portion 104 has an inner surface 119 and an outer surface 120. The inner surface 119 circumscribes and defines a channel 124 extending through the finish portion 104. The channel 124 of the finish portion 104 is in fluid communication with the channel 118 of the neck portion 106, and thus, the cavity 112 of the base portion 102. The channel 124 of the finish portion 104 is configured to receive a first portion of the deformable sealing member, like deformable sealing member 200 shown in FIGS. 2-3B.

As further shown, the finish portion 104 includes a surface feature 126 on its outer surface 120. The surface feature 126 can be configured to engage with a second portion of the deformable sealing member, like deformable sealing member 200 shown in FIGS. 2-3B. While the surface feature 126 can have a variety of configurations, in this illustrated embodiment, the surface feature 126 is in the form of an indentation that extends circumferentially about a portion of the finish portion 104. As described in more detail below and illustrated in FIGS. 3A and 3B, the indentation 126 is configured to receive, and thus engage, the second portion of the deformable sealing member.

In this illustrated embodiment, the indentation 126 extends between a first segment 128 and a second segment 130 of the outer surface 120. As shown, a surface normal (SN₁) to the first segment 128 extends substantially parallel to a longitudinal axis (L_{A}) of the vial 100. Further, a surface normal (SN₂) to the second segment 130 extends substantially perpendicular to the longitudinal axis (L_{A}) of the vial 100. As such, the surface normal (SN₁) of the first segment 128 and the surface normal (SN₂) of the and second segment 130 extend at an angle of about 90° relative to each other. In other embodiments, the surface normal of the first segment and the surface normal of the second segment can extend from about 25° to 110° relative to each other.

While the indentation 126 can have a variety of configurations, in this illustrated embodiment, the indentation 126 has a concave configuration. As shown, the indentation 126 defines a third segment 132 of the outer surface 120 of the finish portion 104, which extends from a first terminal end 134 to a second terminal end 136. In this illustrated embodiment, the first terminal end 134 defines an edge 138 of the first segment 128 and the second terminal end 136 defines an edge 140 of the second segment 130. The depth of the indentation (D_{I}) is defined by the distance between the first and second terminal ends 134, 136 of the third segment 132 in the longitudinal direction (e.g., the y-direction). In some embodiments, the depth (D_{I}) of the indentation can be from about 10% to about 50% of the thickness (T_{FP1}) of a first portion 104a of the finish portion 104. A person skilled in the art will appreciate based on this disclosure that the depth of the indentation can depend at least upon the thickness of the finish portion and the structural configuration of the deformable sealing member.

In use, as shown in FIG. 2, a deformable sealing member 200 is inserted into the vial 100. While the deformable sealing member 200 can have a variety of configurations, in this illustrated embodiment, the deformable sealing member 200 has a substantially T-shaped configuration that includes a disc-shaped element 202 and an elongated cylindrical element 204 extending therefrom. The disc-shaped element 202 extends from a first surface 206 to a second surface 208. As shown in FIG. 2, the elongated cylindrical element 204 is positioned within the channel 124 of the finish portion 104 and a first portion 210 of the first surface 206 of the disc-shaped element 202 is positioned atop and in contact with the first segment 128 of the outer surface 120 of the finish portion 104.

Once the deformable sealing member 200 is engaged with the vial 100, a protective cap 300 is placed and crimped about the second surface 208 of the disc-shaped element 202 of the deformable sealing member 200 and a portion of the finish portion 104 of the vial 100, as shown in FIGS. 3A and 3B.

The protective cap 300 can have a variety of configurations. In this illustrated embodiment, the protective cap 300 is in the form of a metallic foil. In some embodiments, the protective cap can also include a disc-shaped element with an opening on a top surface thereof that is configured to allow access to the cavity of the base portion of the vial. Alternatively or additionally, the protective cap can include a metal ring that is configured to be crimped around at least a portion of the deformable sealing member and finish portion so as to hold the deformable sealing member in place on the vial.

As shown in FIGS. 3A and 3B, when the protective cap 300 is crimped, a second portion 212 of the first surface 206 of the disc-shaped element 202 is forced against the third segment 132 of the outer surface 120 of the finish portion 104, thereby forming a seal therebetween. When exposed to a low temperature, the deformable sealing member 200 contracts from a first configuration, as shown in FIGS. 3A and 3B, to a second configuration. During contraction, a radial inward force is created, thereby causing the second portion 212 of the disc-shaped element 202 to further compress into the indentation 126. As a result, the integrity of the seal between the deformable sealing member 200 and the third segment 132 of the outer surface 120 of the finish portion 104 is maintained.

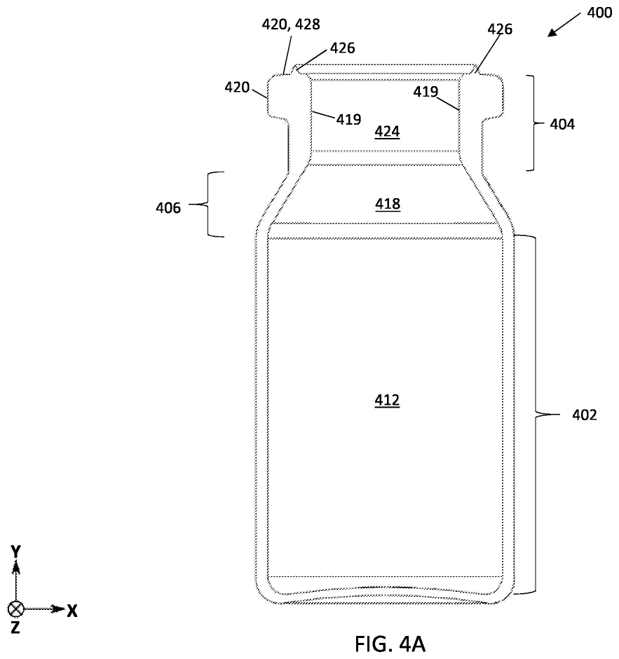

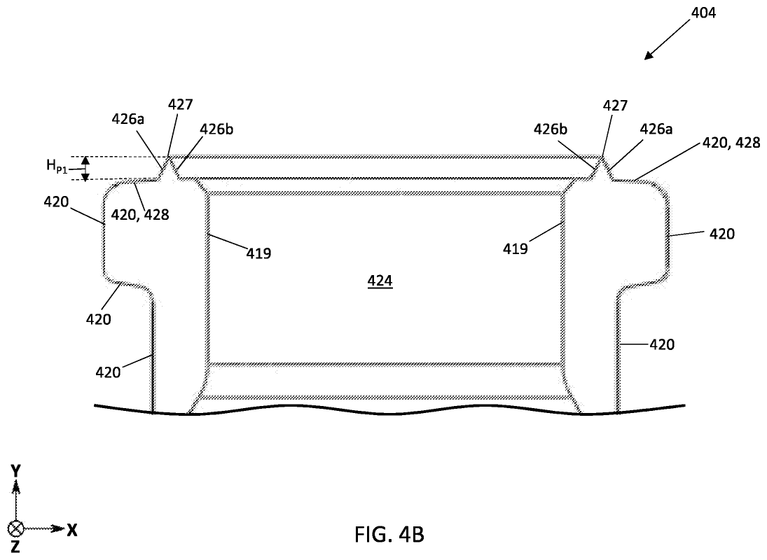

FIGS. 4A and 4B illustrate another embodiment of a vial 400. The illustrated vial 400 generally includes a base portion 402, a finish portion 404, and a neck portion 406 extending therebetween. The base portion 402 and neck portion 406 can be similar to base portion 102 and neck portion 106 shown in FIGS. 1A-3A, and therefore common features are not further described herein.

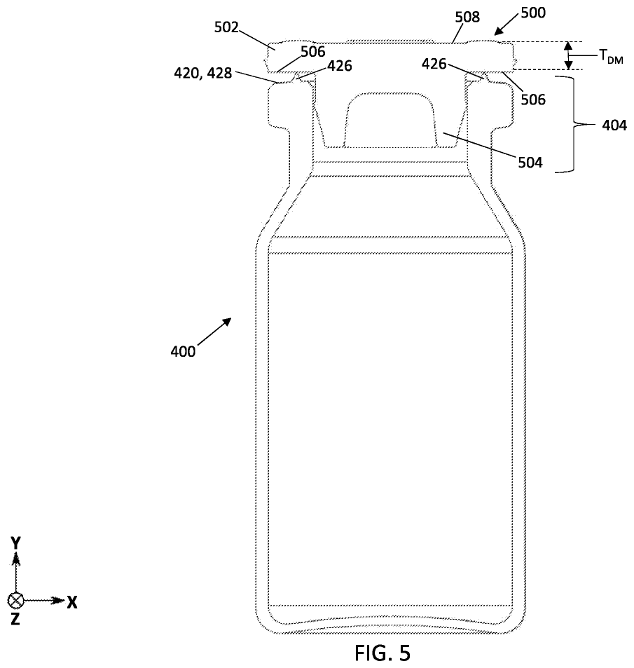

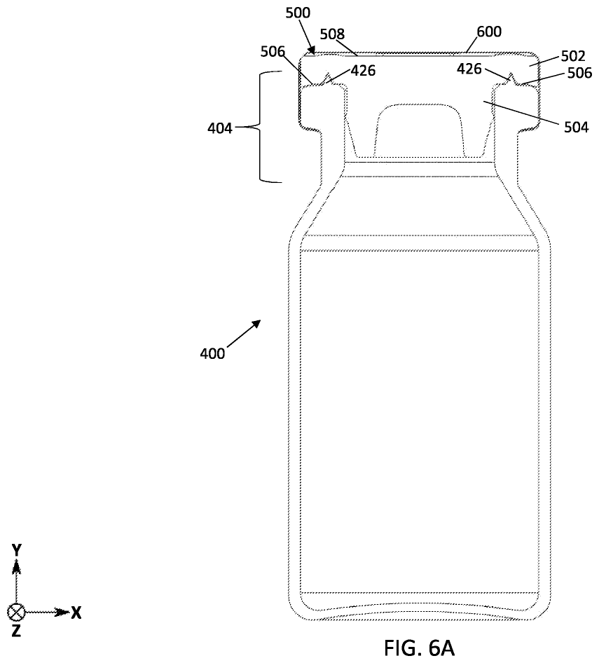

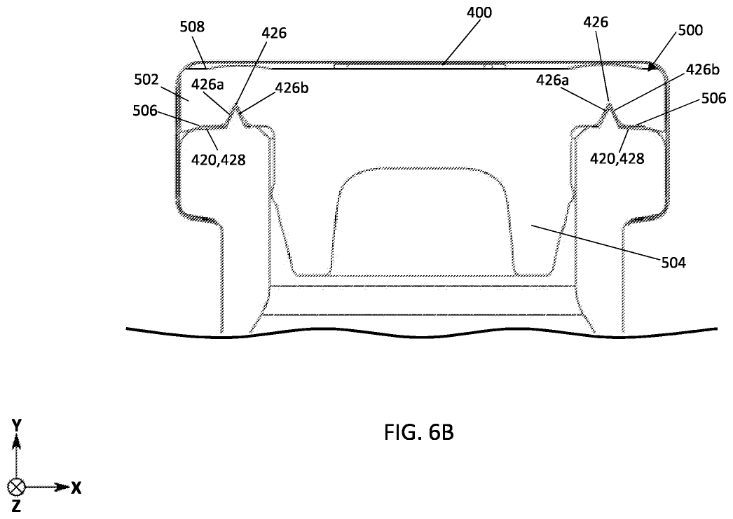

The finish portion 404 can have a variety of configurations. As shown, the finish portion 404 has an inner surface 419 and an outer surface 420. The inner surface 419 circumscribes and defines a channel 424 extending through the finish portion 404. The channel 424 of the finish portion 404 is in fluid communication with the channel 418 of the neck portion 406, and thus the cavity 412 of the base portion 402. The channel 424 of the finish portion 404 is configured to receive a first portion of a deformable sealing member, like deformable sealing member 500 shown in FIGS. 5-6B.

As further shown, the finish portion 404 includes a surface feature 426 extending from a first segment 428 of its outer surface 420. While the surface feature 426 can have a variety of configurations, in this illustrated embodiment, the surface feature 426 is in the form of a protrusion that extends circumferentially about a portion of the finish portion 404. As described in more detail below, the protrusion 426 is configured to penetrate into and engage with a portion of a deformable sealing member, like deformable sealing member 500 shown in FIGS. 5-6B, thereby forming a seal between the finish portion 404 and the deformable sealing member. The protrusion 426 is further configured to remain engaged with the deformable sealing member when the deformable sealing member contracts from a first configuration to a second configuration. As a result, the seal can be maintained when the deformable sealing member, and thus the vial 400, is exposed to a lower temperature.

While the protrusion 426 can have a variety of configurations, in this illustrated embodiment, the protrusion 426 has a substantially triangular configuration. In particular, the protrusion 426 includes two opposing walls 426a, 426b that extend outward from a portion of the first segment 428 of the outer surface 420 and converge at a surface 427 that may be pointed. The pointed surface 427 is configured to push into a portion of a deformable sealing member, like deformable sealing member 500 shown in FIGS. 5-6B.

The height (H_{P1}) of the protrusion 426 is defined by the distance between the first segment 428 of the outer surface 420 and the pointed surface 427 of the protrusion 426 in the longitudinal direction (e.g., the Y-direction). A person skilled in the art will appreciate based on this description that the height (H_{P1}) of the protrusion 426 can depend at least upon structural configuration of a deformable sealing member that is configured to be sealed to the vial 400. For example, in some embodiments, the height (H_{P1}) of the protrusion 426 can be from about 5% to about 50% of the thickness (T_{DM}) of a disc-shaped element of a deformable sealing member, like disc-shaped element 502 of deformable sealing member 500 shown in FIGS. 5-6B.

In use, as shown in FIG. 5, a deformable sealing member 500 is inserted into the vial 400. While the deformable sealing member 500 can have a variety of configurations, in this illustrated embodiment, the deformable sealing member 500 has a substantially T-shaped configuration that includes a disc-shaped element 502 and an elongated cylindrical element 504 extending therefrom. The disc-shaped element 802 extends from a first surface 506 to a second surface 508. As shown in FIGS. 5-6B, the elongated cylindrical element 504 is positioned within the channel 424 of the finish portion 404. Further, the disc-shaped element 502 is positioned atop the pointed surface 427 of the protrusion 426 of the finish portion 404 such that the first surface 506 of the disc-shaped element 502 is facing the first segment 428 of the outer surface 420 of the finish portion 404.

Once the deformable sealing member 500 is inserted into the vial 400, a protective cap 600, like protective cap 300 shown in FIGS. 3A and 3B, is placed and crimped about the second surface 508 of the disc-shaped element 502 of the deformable sealing member 500 and a portion of the finish portion 404 of the vial 400, as shown in FIGS. 6A and 6B. When the protective cap 600 is crimped, the first surface 506 of the disc-shaped element 502 is forced downward toward the vial 400 (e.g., in the y-direction) such that the first surface 506 comes into contact with the two converging walls 426a, 426b of the protrusion 426 and the first segment 428 of the outer surface 420 of the finish portion 404, thereby forming a seal therebetween. As such, at least a portion of the protrusion 426 deforms the deformable sealing member 500. When exposed to a low temperature, the deformable sealing member 500 contracts from a first configuration, as shown in FIGS. 6A and 6B, to a second configuration. During contraction, the penetration of the protrusion 426 within the deformable sealing member 500 inhibits radially movement of the disc-shaped element 502 relative to the first segment 428 of the outer surface 420 of the finish portion 404. Further, the height of the protrusion pushed within the deformable sealing member, which as shown in FIGS. 6A and 6B is substantially equal to the total height (H_{P1}) of the protrusion 426 itself, is designed to be greater that the extent of axial contraction of the deformable sealing member 500. As a result, during contraction, at least a portion of the protrusion 426 deforms the deformable sealing member 500. Thus, the integrity of the seal between the deformable sealing member 500 and the protrusion 426, and thus the vial 400, is maintained.

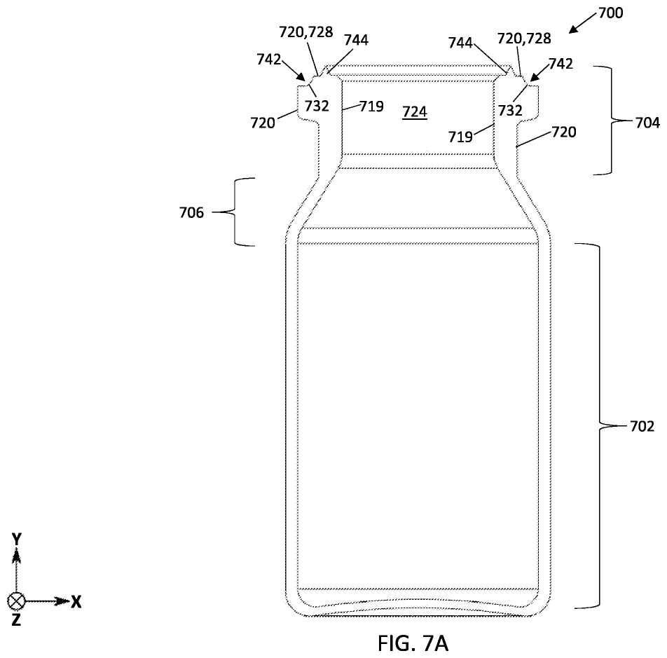

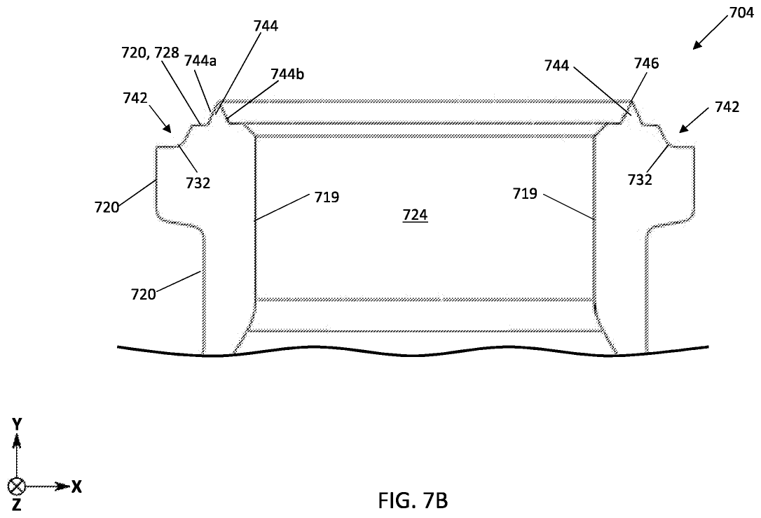

FIGS. 7A and 7B illustrate another embodiment of a vial 700 having a finish portion 704 that is a structural combination of finish portion 104 shown in FIGS. 1A-3B and finish portion 404 shown in FIGS. 4A-6A. In particular, the finish portion 704 extends from an inner surface 719, like inner surfaces 119, 419 of vials 100, 400 shown in FIGS. 1A-3B and 4A-6B, respectively, to an outer surface 720, and includes an indentation 742, like indentation 126 shown in FIGS. 1A-3B, and a protrusion 744, like protrusion 426 in FIGS. 4A-6B.

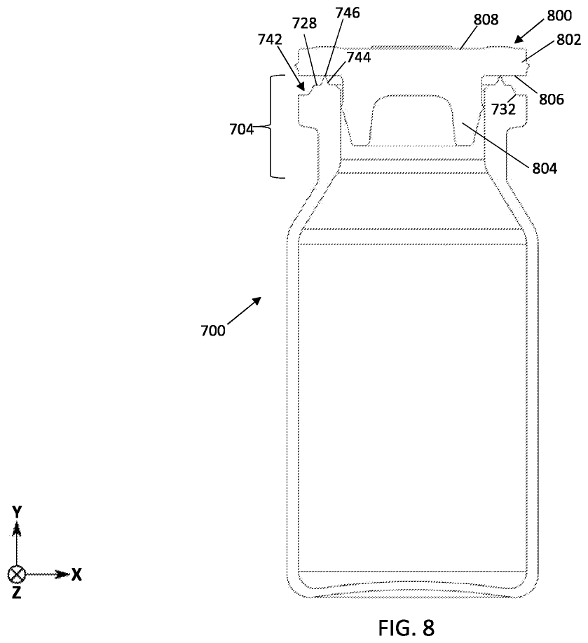

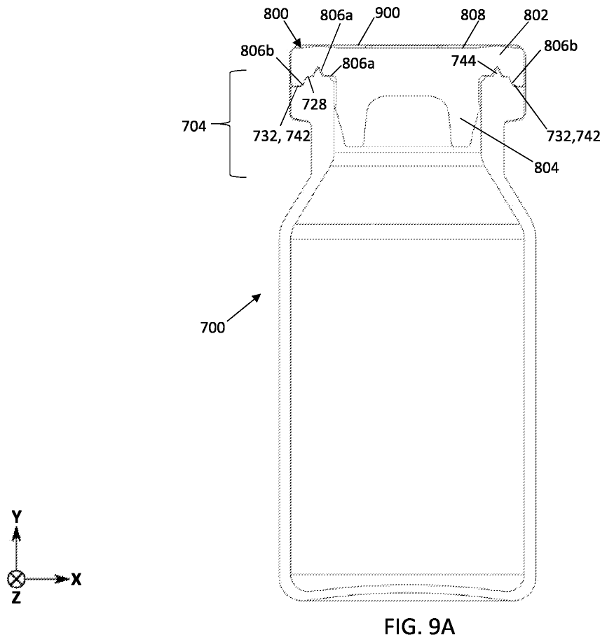

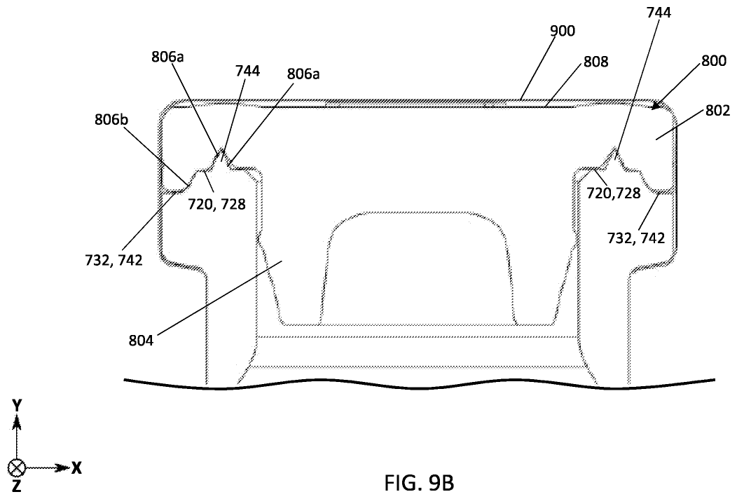

In use, as shown in FIG. 8, a deformable sealing member 800 is inserted into the vial 700. While the deformable sealing member 800 can have a variety of configurations, in this illustrated embodiment, the deformable sealing member 800 has a substantially T-shaped configuration that includes a disc-shaped element 802 and an elongated cylindrical element 804 extending therefrom. The disc-shaped element 802 extends from a first surface 806 to a second surface 808. As shown in FIGS. 8-9B, the elongated cylindrical element 804 is positioned within the channel 724 of the finish portion 704. Further, the disc-shaped element 802 is positioned atop the pointed surface 746 of the protrusion 744 of the finish portion 704 such that the first surface 806 of the disc-shaped element 802 is facing the first segment 728 of the outer surface 720 of the finish portion 704.

Once the deformable sealing member 800 is inserted into the vial 700, a protective cap 900, like protective cap 300 shown in FIGS. 3A and 3B, is placed and crimped about the second surface 808 of the disc-shaped element 802 of the deformable sealing member 800 and a portion of the finish portion 704 of the vial 700, as shown in FIGS. 8A and 8B. When the protective cap 900 is crimped, the first surface 506 of the disc-shaped element 502 is forced downward toward the vial 400 (e.g., in the y-direction) such that a first portion 806a of the first surface 806 comes into contact with the two converging walls 744a, 744b of the protrusion 744 and the first segment 728 of the outer surface 720 of the finish portion 704, thereby forming a seal therebetween. As such, at least a portion of the protrusion 744 deforms the deformable sealing member 800. Further, when the protective cap 900 is crimped, a second portion 806b of the first surface 806 of the disc-shaped element 802 is forced against the third segment 732 of the outer surface 720 of the finish portion 704, thereby forming a seal therebetween. Thus, two seals are formed between the finish portion 704 of the vial 700 and the disc-shaped element 802 of the deformable sealing member 800.

When exposed to a low temperature, the deformable sealing member 800 contracts from a first configuration, as shown in FIGS. 9A and 9B, to a second configuration. During contraction, the penetration of the protrusion 744 within the deformable sealing member 800 inhibits radially movement of the first portion 806a of the first surface 806 of the disc-shaped element 802 relative to the first segment 728 of the outer surface 720 of the finish portion 704. Further, due to the height of the protrusion 744 relative to the thickness of the disc-shaped element 802, at least a portion of the protrusion 744 remains embedded within the deformable sealing member 800, and therefore inhibits axial contraction of the deformable sealing member 800 from compromising the seal formed therebetween. Additionally, a radial inward force is created through contraction of the disc-shaped element 802. This causes the second portion 806b of the first surface 806 of the disc-shaped element 802 to further compress into the indentation 742 of the finish portion 704. As a result, the integrity of the seal between the deformable sealing member 800 and the third segment 732 of the outer surface 720 of the finish portion 704 is maintained.

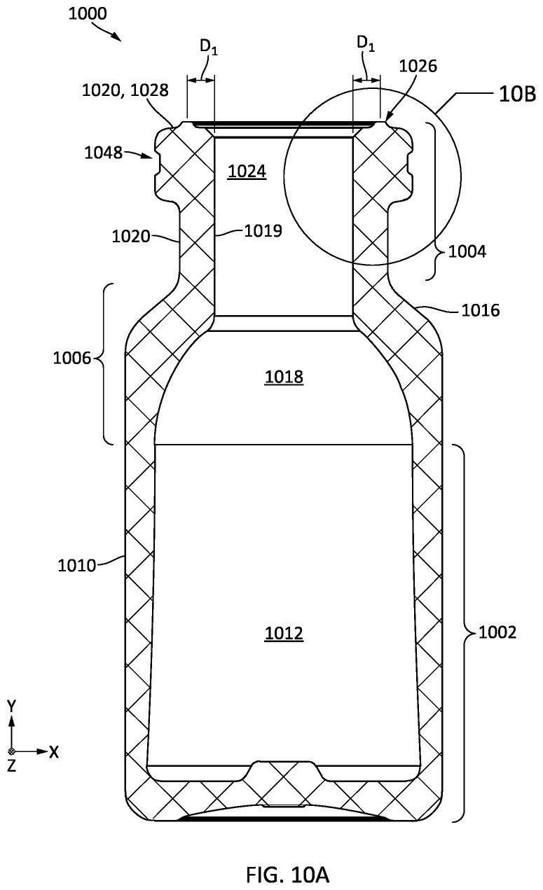

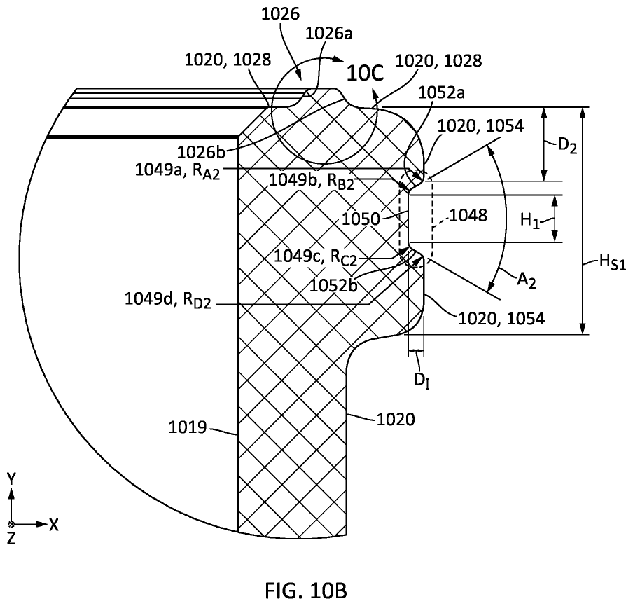

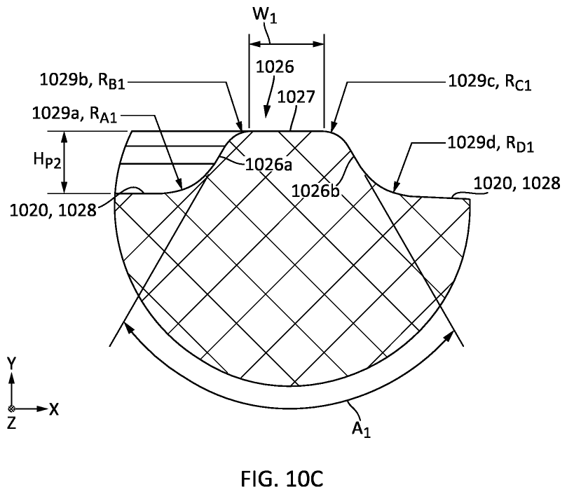

FIGS. 10A-10C illustrate another embodiment of a vial 1000. The illustrated vial 1000 generally includes a base portion 1002, a finish portion 1004, and a neck portion 1006 extending therebetween. The base portion 1002 and neck portion 1006 can be similar to base portion 102 and neck portion 106 shown in FIGS. 1A-3A, and therefore common features are not further described herein.

The finish portion 1004 can have a variety of configurations. As shown, the finish portion 1004 has an inner surface 1019 and an outer surface 1020. The inner surface 1019 circumscribes and defines a channel 1024 extending through the finish portion 1004. The channel 1024 of the finish portion 1004 is in fluid communication with the channel 1018 of the neck portion 1006, and thus the cavity 1012 of the base portion 1002. The channel 1024 of the finish portion 1004 is configured to receive a first portion of a deformable sealing member. The deformable sealing member can have a variety of configurations. For example, the deformable sealing member can be similar to any of the foregoing deformable sealing members 200, 500, 800 shown in FIGS. 2-3A, 5-6A, and 8-9B, respectively.

As further shown, the finish portion 1004 includes a surface feature 1026 extending from a first segment 1028 of its outer surface 1020. While the surface feature 1026 can have a variety of configurations, in this illustrated embodiment, the surface feature 1026 is in the form of a protrusion that extends circumferentially about a portion of the finish portion 1004. As described in more detail below, the protrusion 1026 is configured to engage with a portion of the deformable sealing member, thereby forming a seal between the finish portion 1004 and the deformable sealing member. The protrusion 1026 is further configured to remain engaged with the deformable sealing member when the deformable sealing member contracts from a first configuration to a second configuration. As a result, the seal can be maintained when the deformable sealing member, and thus the vial 1000, is exposed to a lower temperature.

The protrusion 1026 can have a variety of configurations, e.g., a frusto-polygonal shape, such as a frusto-triangular shape, a frusto-pyramidal shape, a frusto-conical shape, a frusto-quadrilateral shape, a frusto-pentagonal shape, a frusto-hexagonal shape, a frusto-heptagonal shape, a frusto-octagonal shape, and the like. In this illustrated embodiment, the protrusion 1026 has a frusto-triangular shape with four corners 1029a, 1029b, 1029c, 1029d, each of which may be radiused.

The protrusion 1026 includes first and second opposing walls 1026a, 1026b that extend outward from a portion of the first segment 1028 of the outer surface 1020 towards a surface 1027. In this illustrated embodiment, the surface 1027 is planar and extends substantially parallel to the first segment 1028 of the outer surface 1020 in the lateral direction (e.g., the X-direction).

As shown in more detail in FIG. 10C, the first and second opposing walls 1026a, 1026b are sloped and extend at an angle (A₁) relative to each other. In some embodiments, the angle (A₁) can be between 0 degrees and 90 degrees. In certain embodiments, the angle (A₁) can be from about 10 degrees to 60 degrees, from about 20 degrees to 50 degrees, or from about 40 degrees to 50 degrees. In one embodiment, the angle (A₁) can be from about 45 degrees to 55 degrees. In another embodiment, the angle (A₁) can be about 50 degrees. In other embodiments, one or both of the opposing walls 1026a, 1026b can extend about 90 degrees relative to the first segment 1028 of the outer surface 1020.

The nominal width (W₁) of the protrusion 1026 is defined by the width of the planar surface 1027 in the lateral direction (e.g., the X-direction). A person skilled in the art will appreciate based on this description that the nominal width (W₁) of the protrusion 1026 can depend at least upon the structural configuration of a deformable sealing member that is configured to be sealed to the vial 1000 and the width of the first segment 1028 of the outer surface 1020. For example, in some embodiments, the nominal width (W₁) of the protrusion 1026 can be between 0 mm and 6 mm. In certain embodiments, the nominal width (W₁) of the protrusion 1026 can be from about 0.1 to 6 mm, from about 0.1 mm to 5 mm, from about 0.1 mm to 2 mm, from about 0.1 mm to 1.5 mm, from about 0.1 to 1 mm, from about 0.1 to 0.5 mm, or from about 0.2 mm to 0.5 mm. In one embodiment, the nominal width (W₁) of the protrusion 1026 can be about 0.41 mm.

While the four corners 1029a, 1029b, 1029c, 1029d of the protrusion 1026 can have a variety of configurations, in this illustrated embodiment, the four corners 1029a, 1029b, 1029c, 1029d are rounded each with a corresponding radius of curvature R_{A1}, R_{B1}, R_{C1}, R_{D1}. A person skilled in the art will appreciate based on this description that the radius of curvature of each of the rounded corners can depend at least upon the manufacturing tolerances in the production of the vial. For example, in some embodiments, at least one radius of curvature R_{A1}, R_{B1}, R_{C1}, R_{D1} can be from about 0 mm to 0.5 mm, about 0.1 mm to 0.4 mm, or from about 0.15 to 0.3 mm. Further, in some embodiments, at least two radii R_{A1}, R_{B1}, R_{C1}, R_{D1} can be the same, whereas in other embodiments, each radius of curvature R_{A1}, R_{B1}, R_{C1}, R_{D1} can be different. In one embodiment, the two radii R_{A1} and R_{D1} are each about 0.3 mm and the two radii R_{B1} and R_{C1} are each about 0.15 mm.

The height (H_{P2}) of the protrusion 1026 is defined by the distance between the first segment 1028 of the outer surface 1020 and the planar surface 1027 of the protrusion 1026 in the longitudinal direction (e.g., the Y-direction). A person skilled in the art will appreciate based on this description that the height (H_{P2}) of the protrusion 1026 can depend at least upon structural configuration of a deformable sealing member that is configured to be sealed to the vial 1000. For example, in some embodiments, the height (H_{P2}) of the protrusion 1026 can be between 0 mm and 0.5 mm. In certain embodiments, the height (H_{P2}) of the protrusion 1026 can be from about 0.1 mm to 0.5 mm, from about 0.2 mm to 0.5 mm, or from about 0.2 mm to 0.45 mm. In one embodiment, the height (H_{P2}) of the protrusion 1026 can be about 0.3 mm, whereas in another embodiment, the height (H_{P2}) of the protrusion 1026 can be about 0.43 mm.

Further, as shown in FIGS. 10A-10B, the protrusion 1026 is spaced a distance (D_{I}) from at least the inner surface 1019 of the finish portion 1004. In this illustrated embodiment, the distance (D_{I}) is defined by the distance between the center of the protrusion 1026 and the inner surface 1019 in the lateral direction (e.g., the X-direction). A person skilled in the art will appreciate based on this description that the distance (D_{I}) between the center of the protrusion 1026 and the inner surface 1019 can depend at least upon structural configuration of a deformable sealing member that is configured to be sealed to the vial 1000 and the width of the first segment 1028 of the outer surface 1020. For example, in some embodiments, the distance (D_{I}) between the center of the protrusion 1026 and the inner surface 1019 can be between 0 mm and 3 mm. In certain embodiments, the distance (D_{I}) between the center of the protrusion 1026 and the inner surface 1019 can be from about 0.5 mm to 2 mm or from about 1 mm to 1.5 mm. In one embodiment, the distance (D_{I}) between the center of the protrusion 1026 and the inner surface 1019 can be about 1.2 mm to 1.5 mm.

In use, a deformable sealing member is inserted into the vial 1000. While the deformable sealing member can have a variety of configurations, for purposes of this discussion with respect to vial 1000, the deformable sealing member is the deformable sealing member 500 shown in FIGS. 5-6B. More specifically, the elongated cylindrical element 504 is positioned within the channel 1024 of the finish portion 1004, and the disc-shaped element 502 is positioned atop the planar surface 1027 of the protrusion 1026. As a result, the first surface 506 of the disc-shaped element 502 faces the first segment 1028 of the outer surface 420 of the finish portion 404.

Once the deformable sealing member 500 is inserted into the vial 1000, a protective cap is placed and crimped about the second surface 508 of the disc-shaped element 502 of the deformable sealing member 500 and a portion of the finish portion 1004 of the vial 1000. While the protective cap can have a variety of configurations, for purposes of this discussion with respect to vial 1000, the protective cap is the protective cap 600 shown in FIGS. 6A-6B.

When the protective cap 600 is crimped, the first surface 506 of the disc-shaped element 502 is forced downward toward the vial 1000 (e.g., in the y-direction) such that the first surface 506 comes into contact with the two opposing walls 1026a, 1026b of the protrusion 1026 and the first segment 1028 of the outer surface 1020 of the finish portion 1004, thereby forming a seal therebetween. As such, at least a portion of the protrusion 1026 is nested within the deformable sealing member 500. When exposed to a low temperature, the deformable sealing member 500 contracts from a first configuration to a second configuration. During contraction, the nesting of the protrusion 1026 within the deformable sealing member 500 inhibits radially movement of the disc-shaped element 502 relative to the first segment 1028 of the outer surface 1020 of the finish portion 1004. Further, the height of the protrusion 1026 nested within the deformable sealing member is designed to be greater than the extent of axial contraction of the deformable sealing member 500. As a result, during contraction, at least a portion of the protrusion 1026 remains embedded within the deformable sealing member 500. Thus, the integrity of the seal between the deformable sealing member 500 and the protrusion 1026, and thus the vial 1000, is maintained.

In some embodiments, the vial 1000 can include additional features, such as a retention element 1048 that is configured to be grasped by automated or manual handling equipment, such as a gripper, to allow the vial 1000 to be manipulated during processing. According to an embodiment, the vial 1000 can be held via the retention element 1048 while the vial 1000 is being coated with one or more materials, e.g., materials that can inhibit the ingress and/or egress of moisture and air through the walls of the vial. Further, holding the vial 1000 by the retention element 1048 can provide 360 degrees access to at least one outer surface of the vial 1000 (e.g., the outer surface 1010 of the base portion 1002, the outer surface 1016 of the neck portion 1006, and/or the outer surface 1020 of the finish portion 1004). As a result, a substantially uniform coating of the one or more materials onto the at least one outer surface of the vial 1000 can be achieved.

While the retention element 1048 can have a variety of configurations, as shown in FIG. 10A, and in more detail in FIG. 10B, the retention element 1048 is in the form of a recess that extends circumferentially about a second segment 1054 of the finish portion 1004. In particular, the recess 1048 has an inverted frusto-triangular shape with four corners 1049a, 1049b, 1049c, 1049d. As a result, the recess 1048 defines a channel within the second segment 1054 of the finish portion 1004 that is configured to receive a piece of handling equipment, such as a gripper or track, that holds the vial 1000 during one or more coating processes. In other embodiments, the recess 1048 can have any other suitable shape, such as other frusto-polygonal shapes.

The recess 1048, as shown in more detail in FIG. 10B, includes a base surface 1050 and two opposing walls 1052a, 1052b extending inward from the second segment 1054 of the outer surface 1020 to the base surface 1050. In this illustrated embodiment, the base surface 1050 is planar and extends substantially parallel to the second segment 1054 of the outer surface 1020 in the longitudinal direction (e.g., the Y-direction).

As shown in more detail in FIG. 10B, the first and second opposing walls 1052a, 1052b, are sloped, and extend at an angle (A₂) relative to each other. In some embodiments, the angle (A₂) can be between 0 degrees and 90 degrees. In certain embodiments, the angle (A₂) can be from about 10 degrees to 80 degrees, from about 20 degrees to 50 degrees, from about 40 degrees to 50 degrees, or from 55 degrees to 65 degrees. In one embodiment, the angle (A₂) can be about 60 degrees. In other embodiments, one or both of the opposing walls 1052a, 1052b can extend about 90 degrees relative to the second segment 1054 of the outer surface 1020.

The nominal height (H₁) of the recess 1048 is defined by the height of the planar base surface 1050 in the longitudinal direction (e.g., the Y-direction). A person skilled in the art will appreciate based on this description that the nominal height (H₁) of the recess 1048 can depend at least upon the geometry of the handling equipment, such as a gripper, that grasps and holds the vial during one or more coating processes. For example, in some embodiments, the nominal height (H₁) of the recess 1048 can be between 0 mm and 2 mm. In certain embodiments, the nominal height (H₁) of the recess 1048 can be from about 0.5 mm to 1.5 mm, from about 0.5 mm to 1.5 mm, or from about 1 mm to 2 mm.

While the four corners 1049a, 1049b, 1049c, 1049d of the recess 1048 can have a variety of configurations, in this illustrated embodiment, the four corners 1049a, 1049b, 1049c, 1049d are rounded each with a corresponding radius of curvature R_{A2}, R_{B2}, R_{C2}, R_{D2}. A person skilled in the art will appreciate based on this description that the radius of curvature of each of the rounded corners can depend at least upon the geometry the handling equipment, such as a gripper, that grasps and holds the vial during one or more coating processes. For example, in some embodiments, at least one radius of curvature R_{A2}, R_{B2}, R_{C2}, R_{D2} can be from about 0 mm to 0.5 mm, about 0.1 mm to 0.4 mm, or from about 0.15 mm to 0.3 mm. Further, in some embodiments, at least two radii R_{A2}, R_{B2}, R_{C2}, R_{D2} can be the same, whereas in other embodiments, each radius of curvature R_{A2}, R_{B2}, R_{C2}, R_{D2} can be different. In one embodiment, each radii R_{A2}, R_{B2}, R_{C2}, R_{D2} can be about 0.13 mm.

The depth (D_{I}) of the recess 1048 is defined by the distance between the second segment 1054 of the outer surface 1020 and the base surface 1050 of the recess 1048 in the lateral direction (e.g., the X-direction). A person skilled in the art will appreciate based on this description that the depth (D_{I}) of the recess 1048 can depend at least upon the geometry of the handling equipment, such as a gripper or track, that grasps and holds the vial during one or more coating processes. For example, in some embodiments, the depth (D_{I}) of the recess 1048 can be between 0 mm and 0.5 mm. In certain embodiments, the depth (D_{I}) of the recess 1048 can be from about 0.05 mm to 0.5 mm, from about 0.05 mm to 0.4 mm, or from about 0.2 mm to 0.3 mm. In one embodiment, the depth (D_{I}) of the recess 1048 can be about 0.25 mm.

Further, as shown in FIGS. 10A-10B, the recess 1048 is spaced a distance (D₂) from at least the first segment 1028 of the finish portion 1004. In this illustrated embodiment, the distance (D₂) is defined by the distance from the first segment 1028 of the outer surface 1020 to the first rounded corner 1049a in the longitudinal direction (e.g., the Y-direction). A person skilled in the art will appreciate based on this description that the distance (D₂) from the first segment 1028 of the outer surface 1020 to the first rounded corner 1049a of the recess 1048 can depend at least upon the height (H_{S1}) of the second segment 1054 of the outer surface 1020. For example, in some embodiments, the distance (D₂) can be between 0 mm and 3 mm. In certain embodiments, the distance (D₂) can be from about 0.5 mm to 2 mm, from about 1 mm to 2 mm, or from about 1 mm to 1.5 mm. In one embodiment, the distance (D₂) can be about 1.2 mm.

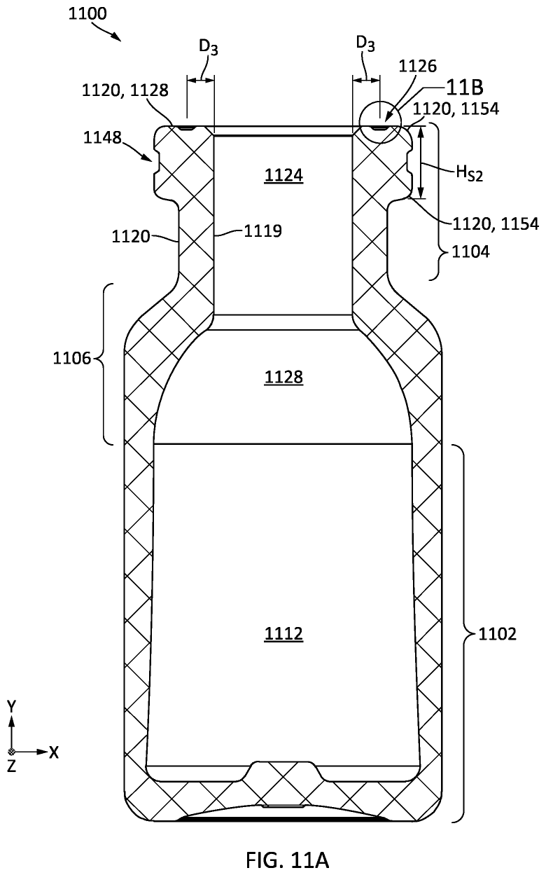

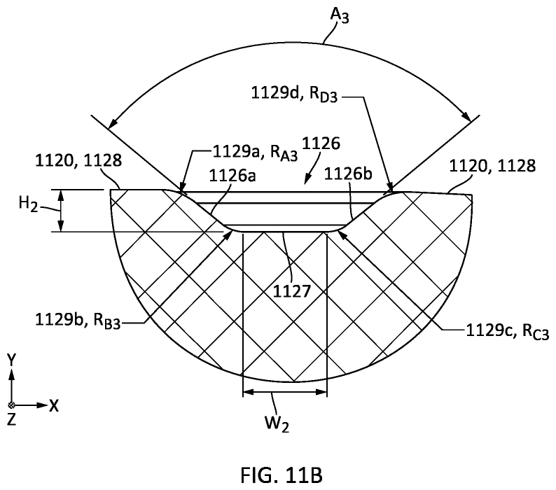

FIGS. 11A-11B illustrate another embodiment of a vial 1100. The illustrated vial 1100 generally includes a base portion 1102, a finish portion 1104, and a neck portion 1106 extending therebetween. The base portion 1102 and neck portion 1106 can be similar to base portion 102 and neck portion 106 shown in FIGS. 1A-3A, and therefore common features are not further described herein. Further, the illustrated vial 1100 also includes a retention element 1148 that can be similar to the retention element 1048 shown in FIGS. 10A and 10B, and therefore common features are not further described here.

The finish portion 1104 can have a variety of configurations. As shown, the finish portion 1104 has an inner surface 1119 and an outer surface 1120. The inner surface 1119 circumscribes and defines a channel 1124 extending through the finish portion 1104. The channel 1124 of the finish portion 1104 is in fluid communication with the channel 1108 of the neck portion 1106, and thus the cavity 1112 of the base portion 1102. The channel 1124 of the finish portion 1104 is configured to receive a first portion of a deformable sealing member. The deformable sealing member can have a variety of configurations. For example, the deformable sealing member can be similar to any of the foregoing deformable sealing members 200, 500, 800 shown in FIGS. 2-3A, 5-6A, and 8-9B, respectively.

As further shown, the finish portion 1104 includes a surface feature 1126 extending inward from a first segment 1128 of its outer surface 1120. While the surface feature 1126 can have a variety of configurations, in this illustrated embodiment, the surface feature 1126 is in the form of an indentation that is concave and extends circumferentially about a portion of the finish portion 1104. As described in more detail below, the indentation 1126 is configured to engage with a portion of the deformable sealing member, thereby forming a seal between the finish portion 1104 and the deformable sealing member. The indentation 1126 is further configured to remain engaged with the deformable sealing member when the deformable sealing member contracts from a first configuration to a second configuration. As a result, the seal can be maintained when the deformable sealing member, and thus the vial 1100, is exposed to a lower temperature.

The indentation 1126 can have a variety of configurations, e.g., a frusto-polygonal shape, such as a frusto-triangular shape, a frusto-pyramidal shape, a frusto-conical shape, a frusto-quadrilateral shape, a frusto-pentagonal shape, a frusto-hexagonal shape, a frusto-heptagonal shape, a frusto-octagonal shape, and the like. In this illustrated embodiment, the indentation 1126 has a has an inverted frusto-triangular shape with radiused corners 1129a, 1129b, 1129c, 1129d. As a result, the indentation 1126 defines a channel within the first segment 1128 of the finish portion 1104 that is configured to receive a portion of a deformable sealing member.

The indentation 1126, as shown in more detail in FIG. 11B, includes a base surface 1127 and two opposing walls 1126a, 1126b extending inward from the first segment 1128 of the outer surface 1120 to the base surface 1127. In this illustrated embodiment, the base surface 1127 is planar and extends substantially parallel to the first segment 1128 of the outer surface 1120 in the longitudinal direction (e.g., the Y-direction).

As shown in more detail in FIG. 11B, the first and second opposing walls 1126a, 1126b are sloped and extend at an angle (A₂) relative to each other. In some embodiments, the angle (A₃) can be between 0 degrees and 120 degrees. In certain embodiments, the angle (A₃) can be from about 10 degrees to 110 degrees, from about 90 degrees to 120 degrees, or from about 100 degrees to 110 degrees. In one embodiment, the angle (A₃) is from about 100 degrees to 110 degrees. In another embodiment, the angle (A₃) can be about 103 degrees. In other embodiments, one or both of the opposing walls 1126a, 1126b can extend about 90 degrees relative to the first segment 1128 of the outer surface 1120.

The nominal width (W₂) of the indentation 1126 is defined by the width of the planar base surface 1127 in the lateral direction (e.g., the X-direction). A person skilled in the art will appreciate based on this description that the nominal width (W₂) of the indentation 1126 can depend at least upon the structural configuration of a deformable sealing member that is configured to be sealed to the vial 1100 and the width of the first segment 1128 of the outer surface 1120. For example, in some embodiments, the nominal width (W₁) of indentation 1126 can be between 0 mm and 6 mm. In certain embodiments, the nominal width (W₁) of the indentation 1126 can be from about 0.1 to 6 mm, from about 0.1 mm to 5 mm, from about 0.1 mm to 2 mm, from about 0.1 mm to 1.5 mm, from about 0.1 to 1 mm, from about 0.1 to 0.5 mm or from 0.2 mm to 0.5 mm. In one embodiment, the nominal width (W₁) of the indentation 1126 can be about 0.39 mm.

While the four corners 1129a, 1129b, 1129c, 1129d of the indentation 1126 can have a variety of configurations, in this illustrated embodiment, the four corners 1129a, 1129b, 1129c, 1129d are rounded each with a corresponding radius of curvature R_{A3}, R_{B3}, R_{C3}, R_{D3}. A person skilled in the art will appreciate based on this description that the radius of curvature of each of the rounded corners can depend the manufacturing tolerances in the production of the vial. For example, in some embodiments, at least one radius of curvature R_{A3}, R_{B3}, R_{C3}, R_{D3} can be from about 0 mm to 0.5 mm, about 0.1 mm to 0.4 mm, or from about 0.1 to 0.3 mm. Further, in some embodiments, at least two radii R_{A3}, R_{B3}, R_{C3}, R_{D3} can be the same, whereas in other embodiments, each radius of curvature R_{A3}, R_{B3}, R_{C3}, R_{D3} can be different. In one embodiment, the two radii R_{A3} and R_{D3} are each about 0.25 mm and the two radii R_{B3} and R_{C3} are each about 0.15 mm.

The height (H₂) of the indentation 1126 is defined by the distance between the first segment 1128 of the outer surface 1020 and the base surface 1127 of the indentation 1126 in the longitudinal direction (e.g., the X-direction). A person skilled in the art will appreciate based on this description that the height (H₂) of the indentation 1126 can depend at least upon the structural configuration of the finish portion 104 and the height (H_{S2}) of the second segment 1154 of the finish portion 1104. For example, in some embodiments, the height (H₂) of the indentation 1126 can be between 0 mm and 0.5 mm. In certain embodiments, the height (H₂) of the indentation 1126 can be from about 0.05 mm to 0.5 mm, from about 0.1 mm to 0.5 mm, from about 0.1 mm to 0.4 mm, or from about 0.15 mm to 0.3 mm. In one embodiment, the height (H₂) of the indentation 1126 can be about 0.2 mm.

Further, as shown in FIG. 11A, the indentation 1126 is spaced a distance (D₂) from at least the inner surface 1119 of the finish portion 1104. In this illustrated embodiment, the distance (D₂) is defined by the distance between the center of the indentation 1126 and the inner surface 1119 in the lateral direction (e.g., the X-direction). A person skilled in the art will appreciate based on this description that the distance (D₂) between the center of the indentation 1126 and the inner surface 1119 can depend at least upon structural configuration of a deformable sealing member that is configured to be sealed to the vial 1100 and the width of the first segment 1128 of the outer surface 1120. For example, in some embodiments, the distance (D₂) between the center of the indentation 1126 and the inner surface 1119 can be between 0 mm and 3 mm. In certain embodiments, the distance (D₂) between the center of the indentation 1126 and the inner surface 1119 can be from about 0.5 mm to 2 mm or from about 1 mm to 1.5 mm. In one embodiment, the distance (D₂) between the center of the indentation 1126 and the inner surface 1119 can be about 1.2 mm to 1.5 mm.

In use, a deformable sealing member is inserted into the vial 1100. While the deformable sealing member can have a variety of configurations, for purposes of this discussion with respect to vial 1100, the deformable sealing member is the deformable sealing member 200 shown in FIGS. 2-3B. More specifically, the elongated cylindrical element 204 is positioned within the channel 1124 of the finish portion 1104 and a first portion 210 of the first surface 206 of the disc-shaped element 202 is positioned atop and in contact with the first segment 1128 of the outer surface 1120 of the finish portion 1104.

Once the deformable sealing member 200 is inserted into the vial 1100, a protective cap is placed and crimped about the second surface 208 of the disc-shaped element 202 of the deformable sealing member 200 and a portion of the finish portion 1104 of the vial 1100. While the protective cap can have a variety of configurations, for purposes of this discussion with respect to vial 1100, the protective cap is the protective cap 300 shown in FIGS. 3A-3B.

When the protective cap 300 is crimped, a second portion 212 of the first surface 206 of the disc-shaped element 202 is forced into the indentation 1126, and thus against at least a portion of the two opposing walls 1126a, 1126b, thereby forming a seal therebetween. In some instances, when the disc-shaped element 202 is forced into the indentation 1126, the second portion 212 can also be forced against the base surface 1127. When exposed to a low temperature, the deformable sealing member 200 contracts from a first configuration to a second configuration. During contraction, a radial inward force is created, thereby causing the second portion 212 of the disc-shaped element 202 to further compress into the indentation 1126. As a result, the integrity of the seal between the deformable sealing member 200 and the indentation 1126, and thus the vial 1100, is maintained.

While the retention element is primarily described with respect to the embodiments of FIGS. 10A-11B, a person skilled in the art will understand that the retention element can likewise be used with the embodiments of FIGS. 1-9B, making any modifications that will ensure the appropriate structural dimensions and placement of the retention element on the finish portions.

While the illustrated surface features are shown as an indentation (FIGS. 1A-3B and 11A-11B), a protrusion (FIGS. 4A-6B and 10A-10C), and a combination thereof (FIG. 7A-9B), each of which extends circumferentially about the finish portion, in some embodiments, the indentation and/or protrusion can be discontinuous about the circumference of the finish portion, e.g., broken into multiple segments extending around the circumference of the finish portion. Further, in some embodiments, the surface feature can include two or more features. For example, in one embodiment, the surface feature can include two or more concave indentations. In other embodiments, the surface feature can include two or more protrusions. In yet other embodiments, the surface feature can include two or more protrusions and one or more concave indentations.

Values or ranges may be expressed herein as “about” and/or from/of “about” one particular value to another particular value. When such values or ranges are expressed, other embodiments disclosed include the specific value recited and/or from/of the one particular value to another particular value. Similarly, when values are expressed as approximations, by the use of antecedent “about,” it will be understood that here are a number of values disclosed therein, and that the particular value forms another embodiment. It will be further understood that there are a number of values disclosed therein, and that each value is also herein disclosed as “about” that particular value in addition to the value itself. In embodiments, “about” can be used to mean, for example, within 10% of the recited value, within 5% of the recited value or within 2% of the recited value.

For purposes of describing and defining the present teachings, it is noted that unless indicated otherwise, the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety. Any patent, publication, or information, in whole or in part, that is said to be incorporated by reference herein is incorporated herein only to the extent that the incorporated material does not conflict with existing definitions, statements, or other disclosure material set forth in this document. As such the disclosure as explicitly set forth herein supersedes any conflicting material incorporated herein by reference.

What is claimed is:

1. A vial, comprising:
a base portion having an inner surface defining a cavity that is configured to selectively hold a medicament; and
a finish portion having an outer surface and an inner surface, the inner surface defining a channel that is in fluid communication with the cavity, the channel being configured to receive a first portion of a deformable sealing member, the finish portion comprising on the outer surface thereof,
a surface feature that is configured to engage with a second portion of the deformable sealing member,
wherein the surface feature is configured to remain engaged with the second portion of the deformable sealing member when the deformable sealing member contracts from a first configuration to a second configuration, thereby maintaining a seal between the finish portion and the deformable sealing member.

2. The vial of claim 1, wherein the surface feature is at least one of an indentation that is configured to receive the second portion of the deformable sealing member and a protrusion that is configured to penetrate the second portion of the deformable sealing member.

3. The vial of claim 2, wherein at least one of the indentation or the protrusion extends circumferentially about at least a portion of the finish portion.

4. The vial of claim 3, wherein the protrusion terminates at a surface that is configured to push into the second portion of the deformable sealing member.

5. The vial of claim 1, further comprising a neck portion extending from the base portion to the finish portion, wherein the neck portion having an outer surface and inner surface, the inner surface defining a channel that is in fluid communication with the channel of the finish portion and the cavity of the base portion.

6. The vial of claim 1, wherein the deformable sealing member has a Shore hardness from about 40 A to 70 A.

7. The vial of claim 1, wherein the deformable sealing member has a Shore hardness from about 45 A to 55 A.

8. The vial of claim 1, wherein the deformable sealing member has a substantially T-shaped configuration.

9. The vial of claim 1, further comprising a protective cap that is configured to be selectively crimped around at least a portion of the finish portion so as to selectively seal the deformable sealing member to the finish portion.

10. The vial of claim 8, wherein the protective cap includes a metallic foil.

11. The vial of claim 1, wherein the deformable sealing member contracts from the first configuration to the second configuration when the vial is exposed to a temperature from about −25° C. to −196° C.

12. The vial of claim 11, wherein the temperature is from about −85° C. to −75° C.

13. The vial of claim 11, wherein the temperature is from about −196° C. to −120° C.

14. The vial of claim 1, wherein the vial further comprises the medicament disposed within the cavity of the base portion.

15. The vial of claim 1, wherein the surface feature includes one or more concave indentations.

16. The vial of claim 1, wherein the surface feature includes one or more triangular protrusions.

17. The vial of claim 1, wherein the surface feature includes one or more triangular protrusions and one or more concave indentations.

18. The vial of claim 1, wherein the surface feature includes one or more protrusions each having at least one planar surface.

19. The vial of claim 18, wherein the surface feature includes one or more concave indentations.

20. The vial of claim 1, wherein the surface feature includes one or more protrusions having a frusto-polygonal shape.

21. The vial of claim 1, wherein the surface feature includes one or more indentations having an inverted frusto-polygonal shape.

22. The vial of claim 1, wherein the surface feature includes first and second opposing walls that extend at an angle relative to each other.

23. The vial of claim 22, wherein the angle is from about 45 degrees to 55 degrees.

24. The vial of claim 22, wherein the angle is from about 100 degrees to 110 degrees.

25. The vial of claim 1, wherein the surface feature has a width from about 0.2 mm to 0.5 mm.

26. The vial of claim 1, wherein the surface feature has a height from about 0.1 mm to 0.5 mm.
